(19) United States
(12) Patent Application Publication
(10) Pub. No.: US 2007/0011024 A1
(43) Pub. Date: Jan. 11, 2007

(54) Business method - global data center for quality assessment and improvement system (GDC-QAISys)

(76) Inventors: Richard B. Dale, Chesterfield, IN (US); Jeremiah C. Loveland, Anderson, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/178,082

(22) Filed: Jul. 8, 2005

(51) Int. Cl. G06Q 10/00; H04M 3/51

(52) U.S. Cl. 705/2; 705/11

(57) ABSTRACT

A BUSINESS METHOD in Health Care Management. This relates to a Global Data Center (GDC) for quality assessment and improvement in a medical imaging department by a quality assessment and improvement system (QAISys). Other healthcare areas may similarly benefit from this method. The method provides a unique way to combine computer assisted data exchange between healthcare facilities in the areas of administering, managing, and operating its Quality improvement activities. It provides feedback, instruction, and improvement ideas to enhance the skills of the personnel. National quality benchmarks for procedures and tests are established and monitored. This method is specific to the facility yet draws global national benchmarks from the database. Imaging technologists are the preferred use for this method. This provides a way to combine various existing healthcare systems with simple, new global analysis to accomplish concrete, useful and tangible improvements for the specific healthcare groups.

### CROSS-REFERENCE TO RELATED APPLICATIONS

This application is related to patent application Ser. No. 11/125,527 filed May 10, 2005 titled Medical Imaging—Quality Assessment and Improvement System (QAISys).

### FIELD OF INVENTION

This present improvement relates to A BUSINESS METHOD in Health Care Management, specifically related to a business method using a Global Data Center (GDC) for quality assessment and improvement to Medical Imaging and related radiology tests and assessments. The method provides a unique way to combine computer assisted data exchange with the implementation of administering, managing and operating the Quality improvement activities of healthcare groups. The method provides a technique to aid in the feedback, instruction, and improvement to the medical personnel and technologists. Overall in this business method the national benchmarks of the level of quality for healthcare procedures and tests are monitored and established.

The method is specific to the QAISys system for improvement to the collective individual skills of the personnel and technologists at a given facility or set of healthcare facilities. The preferred group demonstrated in this business method relates to technologists responsible for medical imaging. However, the method provides an alternative way to combine various existing systems with simple, new analysis to accomplish concrete, useful and tangible results in improvement of the specific healthcare area utilizing this business method. Therefore the scope and spirit of this business method comprises and anticipates specifically the radiological imaging areas and generally the entire healthcare systems. These systems must be where local measurements may be collectively transferred to a national or global database in order to establish benchmarks and encourage improvement to the individual facility or group.

### FEDERALLY SPONSORED RESEARCH

Not Applicable.

### SEQUENCE LISTING OR PROGRAM

Not Applicable

### BACKGROUND—FIELD OF INVENTION

An accurate diagnosis of any health condition of a patient is the foundation upon which an appropriate medical treatment stands. Various healthcare personnel, especially including those responsible for medical imaging, are indispensable in the process of diagnosing and monitoring medical treatment for pathologies and injuries. The diagnostic value of any result of an imaging technologist person's exam or test is greatly influenced by the competence of the person or technologist performing the procedure or test. Over the last few decades, major advances have been made in equipment and techniques that enable diagnoses to be more accurate, faster, less invasive, and more cost effective. Important to any quality study, especially for medical imaging studies, is the type and strength (i.e. magnetic flux capability) of the equipment being used.

Because of these medical technology improvements, and an aging population, the demand for more and better medical services has increased dramatically. Demands are increasing for more capable healthcare professionals and technologists. Another challenge is the demand by insurance companies, healthcare protocol or “watch” agencies, and healthcare associations to monitor and improve the overall quality of the services provided to the individual patients.

In response to the increasing demand, the latest computer technologies for connectivity are being employed to increase workflow efficiencies. For example, in medical, imaging, Picture Archiving and Communications Systems (PACS) are being integrated with Radiology Information Systems (RIS) so that images, along with their interpretive reports, patient demographics, and previous exams, can be quickly and easily accessed by radiologists and referring physicians. Often the PACS and RIS are connected to the health care facility's own information system (HIS). While these technologies greatly enhance the communication process, they are not yet being utilized to their full potential. The feedback for improvement to individual technologists does not exist. Another limitation is that these health care groups and the facility (or facilities) normally only review internal data specific to the individual facility. Recently, there have been proclamations and requests for more medical error reporting system or “MERS”. Even though there has been these governmental edicts to assess and improve the medical benchmarks, to date there is no ongoing correlation to what other national healthcare groups and facilities are accomplishing to improve the quality of their services. While this is a healthcare wide request, the need is more pronounced in areas such as medical imaging where there are professional technologists and medical doctors which depend on each other for interactive communications and high quality results.

A. Introduction of the Problems Addressed

All of the healthcare tests and procedures require professionals who must be able to use available technology and to elicit patient co-operation in order to perform the procedure or exam. Professionals and technologists must have a good understanding of the procedures and the demographics (age, type test, infirm condition, pain level, etc.) in order to maximize the quality of the results. When the quality of a test or procedure is compromised, the personnel should recognize the inadequacy of the test, procedure, environment, technologist, or patient and determine the source that is affecting the test result. The professionals (radiologists, technologists, and healthcare managers) must then seek ways in the future to eliminate the cause or moderate its effect.

Proficiency in overcoming these obstacles is vital, especially within the context of tight examination schedules. A critical need for efficient and professional medical imaging exams and procedures that need to be performed correctly the first time cannot be overstated. Failure to do so can result in missed diagnoses due to compromised results of the exam or procedure. If the patient must be asked to return for a repeat of the exam, it is a hardship for the patient and an expense to the health care provider. Other consequences include delays in report turnaround and increased liability exposure to the medical personnel and facilities.

To date, there has been no consistent exchange of data between healthcare facility groups and the medical doctors, especially radiologists, regarding the quality of service. This inconsistency is especially pronounced in the area of medical imaging. Occasionally, internal benchmarks have been established and individual facilities or healthcare groups have been “measured” and monitored for progress against their own individual level for a department, facility, or group of facilities. However, a comprehensive and holistic national measurement system has not been in place for radiologists and medical imaging technologists (or alternatively for healthcare professionals, administrators, and insurance underwriters) to evaluate the facility or group of facilities against a national benchmark.

B. Prior Art

Historically, the prior art business methods to assess and improve quality for health care exams and procedures have addressed few of these needs. This is especially true for the medical imaging areas. Importantly, never has any prior art provided a solution in one system or method to virtually address all the above stated problems, especially in the area of medical imaging.

Examples of data manipulation art for health facilities include a publication U.S. 2001/0032101 A1 provided by Statius Muller (Oct. 18, 2001). This teaches and describes a specific way to manage and store specific data on patients and an ability to retrieve the data rapidly. There is no discussion of using the data to improve the quality derived from individual health care professionals, technologists or departments. There also is no anticipation of collecting the data for creation of national norms for the quality of the exams. Another publication U.S. 2001/0051881 A1 provided by Filler (Dec. 13, 2001) teaches a system and method to transfer data from one location where a test or image was created to a remote location where a professional, such as a radiologist, might interpret the image. There is no mention of recording the image quality and potential causes of poor quality and relate that quality level back to a quality norm (national or local) for assessment and improvement. This data for improvement could go to the facility or to the technologist that created the image. A U.S. Pat. No. 6,353,802 issued to Barbur et al. (Mar. 5, 2002) teaches basic reject analysis through data gathering and statistical manipulation. This does reference radiology and photo processes but does not establish or provide any business method to incorporate the results into an improvement system involving the radiologist, technologist and supervisor. No gathering of data for a national norm is mentioned.

Another medical system performance improvement tool is taught in publication U.S. 2002/0082864 A1 provided by Kelley et al (Jun. 27, 2002). This tool focuses on the equipment used and tracking of image quality. There is no discussion of the technologist's role or exchanging data among various facilities in order to improve the overall healthcare quality. The publication U.S. 2002/0085026 A1 provided by Bocionek et al. (Jul. 4, 2002) is again a pure data collection system in the radiology section of a health facility. This system now known as the Radiology Information System (RIS) primarily matches patient, doctor and imaging data into one system for convenient and rapid computer monitor access by medical personnel. The system does not teach collection and exchange of data between facilities or the creation of any national benchmarks.

The publication U.S. 2002/0131625 A1 provided by Vining et al. (Sep. 19, 2002) teaches an intermediate comment or expert opinion from professional medical personnel such as radiologists and other medical doctors. This is supplemental to the Picture Archival and Communication System (PACS) and provides input to both the Radiology Information System (RIS) and Hospital Information System (HIS). While this may complement the new QAISys presented here, it does not teach or imply the use of the data inputted to improve the quality of the technologists' efforts. Another publication concerning a medical image improvement is a system taught by U.S. 2002/0194019 A1 by Evertsz (Dec. 19, 2002). This system teaches the use of known and unknown diagnosed problem case correlated and tested to determine if a radiologist could or has made a misdiagnosis. Technologist improvements are essentially not addressed. National benchmarking through the collection and analysis of data from many healthcare facilities is not anticipated in this art.

The U.S. Pat. No. 6,574,304 B1 issued to Hsieh et al. (Jun. 3, 2003) teaches a computer aided system that takes existing medical images, analyzes the results by computer, re-determines if other concerns present themselves in addition to the original diagnosis, and even suggests the need for additional images. No technologist improvement data is suggested or taught. The U.S. Pat. No. 6,574,629 B1 issued to Cooke, Jr. et al. (Jun. 3, 2003) teaches the Picture Archiving and Communication System (PACS). This system is used to collect and present medical images but stops short of teaching its use of data collected to be exchanged between facilities or used as a basis for establishing national benchmarks. The publication U.S. 2004/0015372 A1 provided by Bergman et al. (Jan. 22, 2004) teaches a process to collect data in the medical information systems. It elaborates on patient and results information and statistical comparisons. It does not teach or claim using the data for improving capabilities and quality enhancement of the technologists in the medical image field. It teaches no establishment or monitoring of national benchmarks among healthcare facilities.

None of the above described prior art teaches all the features and capabilities of the BUSINESS METHOD USING A GLOBAL DATA CENTER FOR A QUALITY ASSESSMENT and IMPROVEMENT SYSTEM (GDC-QAISys). This is specifically true for medical imaging as well as the general healthcare improvement systems.

### SUMMARY OF THE INVENTION

This new business method is accomplished through a Global Data Center of data from a QUALITY ASSESSMENT and IMPROVEMENT SYSTEM (GDC-QAISys). The steps comprising this new method and the interface of the measurement and monitoring method to other health care information systems provide a complete manner to provide data and a new way to enable greatly improved quality of medical procedures and tests. The several features provided will be described below in the specification and with the accompanying drawings.

Key systems, included in order to query and interface with the technologists, medical doctors, type and status of equipment and other sources to get data and exchange information, are:
i. Existing QAISys or equivalent imaging (and/or healthcare quality system) to gather and organize data;
ii. A means to exchange data between a national archive of data and the individual or group of imaging results and other healthcare reports and inputs from the facilities;
iii. A means to statistically monitor and compare data between a specific facility and the benchmark point and national average; and
iv. A manner to evaluate usage of a specific facility or group and charge costs back to the user group the using healthcare facility or group.

### OBJECTS AND ADVANTAGES

Accordingly, there are several objects and advantages of the BUSINESS METHOD USING A GLOBAL DATA CENTER FOR A QUALITY ASSESSMENT and IMPROVEMENT SYSTEM (GDC-QAISys). One advantage of this method is that it facilitates increased communication from hospital managers and administrators with the medical imaging professionals such as the radiologists, technologists, and radiology managers.

Another advantage and objective of this concept is that it introduces systematic and consistent performance accountability to the healthcare professionals and the imaging professionals as to the quality level and improvement progress of technologists and as to the condition of equipment including, but not limited to, the medical imaging process.

A further advantage is that this business method enables organization-specific quality comparisons and analysis. This provides a direct way to monitor status and improvement of the quality of services provided at the individual healthcare facility or group of facilities (when the facility is monitored and assessed by the QAISys system or its equivalent). These three advantages should in turn improve the overall quality of medical services and images performed at locations where QAISys is implemented.

Implementation of a Global Data Center (GDC) that facilitates collection and analysis of the statistical data harvested by the above described QAISys applications will help facilitate additional improvements. The GDC used in multiple medical facilities will greatly improve the data and analysis available from the implementation of QAISys. The historical data and statistical trends from the GDC will broaden QAISys comparisons and analysis for intra and inter-organizations or on a “global” scale. This adds three very significant advantages to those provided by QAISys:
a. The data will be used to formulate Global QAISys Ratings (GQR) useful as benchmarks against which local (intra-organizational) QAISys Ratings (QR) may be compared. This is will help the managers of the local (imaging) healthcare facilities prioritize their quality improvement efforts.
b. The GQRs will be useful to professional leaders by enabling analysis that shows where improvement efforts should be made by the entire profession. For example in the medical imaging healthcare field: The American Society of Radiologic Technologists (ASRT) may use analysis of GQRs to identify a specific type of medical imaging exam that is consistently dissatisfactory to interpreting radiologists. The ASRT can then target that type of exam for improvement on a national scale. Subsequently, the ASRT will be able to focus their continuing education articles and seminars on communicating best practices and techniques for obtaining optimal image quality. It is reasonable to expect that the GQR for that exam type will demonstrably improve. This healthcare improvement use demonstrated for “medical imaging” is exemplary and not limiting. One skilled in the art of quality assessment and improvement systems well understands how this same business method could easily be translated to other healthcare fields requiring a method to improve its quality of care. Important to note is the importance of having a solid interface between the medical doctor (radiologist) and the technologist and his/her supervisor. This is true in medical imaging and several other healthcare fields. However, this relationship is not universal in the healthcare industry. The relationship of the doctor, technologist and the supervisor of the technologist is a special key to an improvement system and should be considered for any alternative use of the QAISys Global Data System beyond medical imaging.
c. The GQRs will be useful to healthcare (and medical imaging) technology developers by enabling them to identify areas where advances in technology might improve healthcare (image) quality. When a new technology is introduced, comparisons of relevant QRs for facilities where the technology is used can be made with national GQRs and thus demonstrate the advantages of implementing the technology.

Another advantage is the method provides and facilitates communication to other hospital and health care administration as to quality assessment and quality improvement for healthcare exams and procedures such as, for example, medical imaging departments. The system provides data to substantiate improvement as well as need for improvement to quality review groups, to certification activities, and to health care improvement public advocacy groups. The data demonstrates to all, including insurance carriers, that Quality Improvement is being addressed in the healthcare field. The Global System does not advocate listing specific values between system participants, rather it provides national benchmarks as to averages and ranges. Therefore, the confidential data for specific facility(ies) or groups is maintained. However, the internal data for specific subscribers is known and may be compared with national benchmarks in order to promote or urge further improvements in needed areas. Additionally, healthcare providers may understand and encourage the subscribers to compare and continue to improve their own position as to the national averages without divulging current positions for the individual subscriber.

A further advantage is the beneficial impact to health care costs. Improved quality of the healthcare exams and procedures, such as in the medical image quality, result in fewer “re-dos” or “re-takes” of the procedures and tests and thereby removes the duplication costs that a health care provider may often absorbs in its costs. Further, the liability exposure to physicians, health care providers, and technologists should benefit from this improved quality. Patients themselves should ultimately receive better first time images and thus decrease their need for a repeat test. Though the patient may not bear the full cost of the actual test, the patient does bear the loss of time, cost of transportation and the time without the next logical medical procedure when tests are not performed properly the first time. Finally, health care providers, large hospitals or specific contract agencies, will have data to focus additional education and training for technologists. Thereby, un-needed education is avoided and the technologist is trained on the specific machines and procedures that that individual needs for improvement.

A further advantage is the BUSINESS METHOD USING A GLOBAL DATA CENTER FOR QUALITY ASSESSMENT and IMPROVEMENT SYSTEM (GDC-QAISys) does not complicate or interfere with existing systems. The Picture Archiving and Communication System (PACS), the Hospital Information System (HIS), and the Radiology Information Systems (RIS) are not affected by the additional system. QAISys outputs uses data from those systems but does not impact or compromise those input systems.

Finally, other advantages and additional features of the present BUSINESS METHOD USING A GLOBAL DATA CENTER FOR A QUALITY ASSESSMENT and IMPROVEMENT SYSTEM (GDC-QAISys) will be more apparent from the accompanying drawings and from the full description of the instant improvement method. For one skilled in the art of business methods for healthcare facilities and/or quality assessment and improvement systems, it is readily understood that the features shown in the examples with this instant method are readily adapted to the medical imaging field of healthcare. Additionally, several other areas of healthcare may benefit from this method of improvement the quality of systems and services.

### DESCRIPTION OF THE DRAWINGS

The accompanying drawings, which are incorporated in and constitute a part of this specification, illustrate an embodiment of the present method that is preferred. The drawings together with the summary description given above and a detailed description given below serve to explain the principles of the BUSINESS METHOD USING A GLOBAL DATA CENTER FOR A QUALITY ASSESSMENT and IMPROVEMENT SYSTEM (GDC-QAISys). It is understood, however, that the BUSINESS METHOD USING A GLOBAL DATA CENTER FOR A QUALITY ASSESSMENT and IMPROVEMENT SYSTEM (GDC-QAISys) is not limited to only the precise arrangements and instrumentalities shown.

### FIGURES

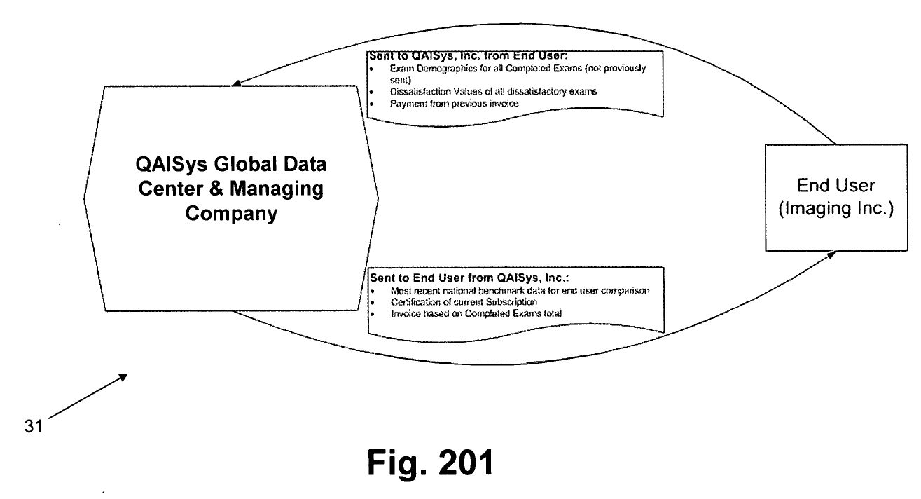

FIG. 201 is a Diagram of a simplified business method for establishing a link and then sharing data relevant to quality improvement for a healthcare provider.

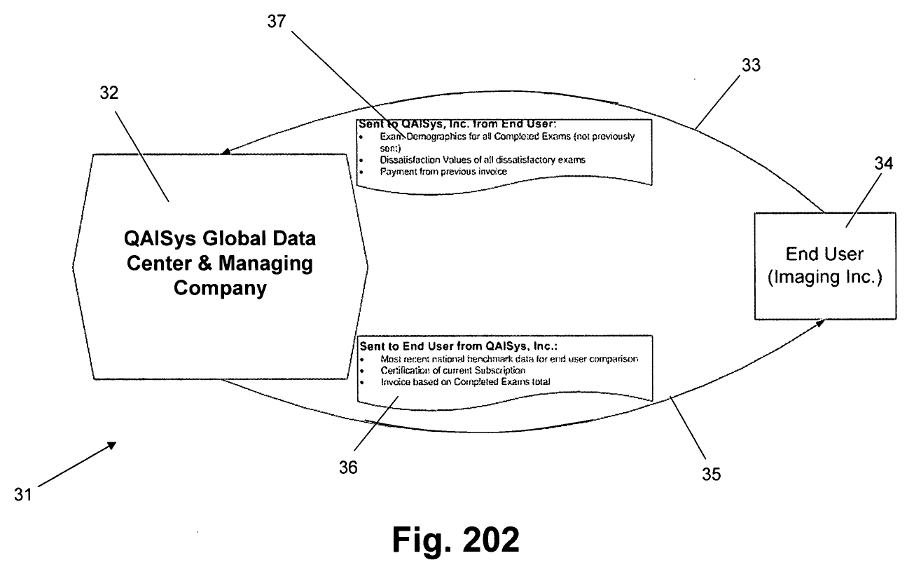

FIG. 202 is the FIG. 201 with the various components and portions of the diagram indicated by their respective reference numbers (see below).

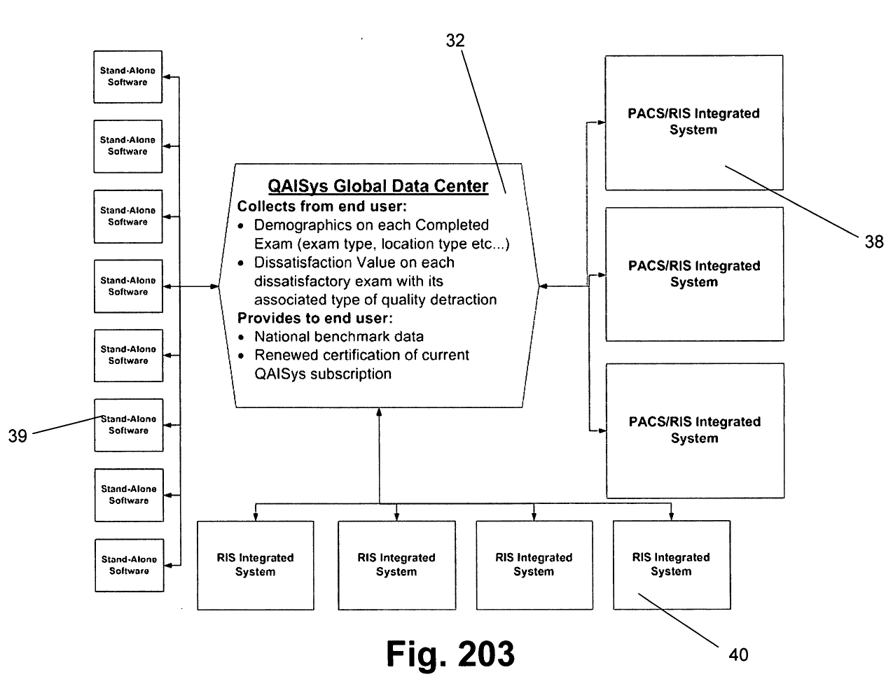

FIG. 203 is an overview of how stand alone facilities and more complexly integrated healthcare groups, with multiple facilities, might be interconnected in a global data interchange system.

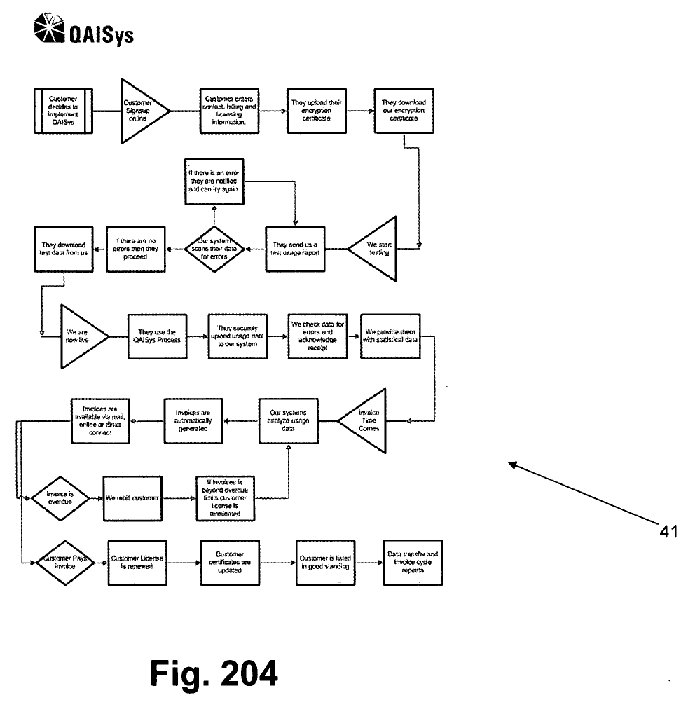

FIG. 204 is a FLOW CHART demonstrating the essential steps for a BUSINESS METHOD USING A GLOBAL DATA CENTER FOR A QUALITY ASSESSMENT and IMPROVEMENT SYSTEM (GDC-QAISys).

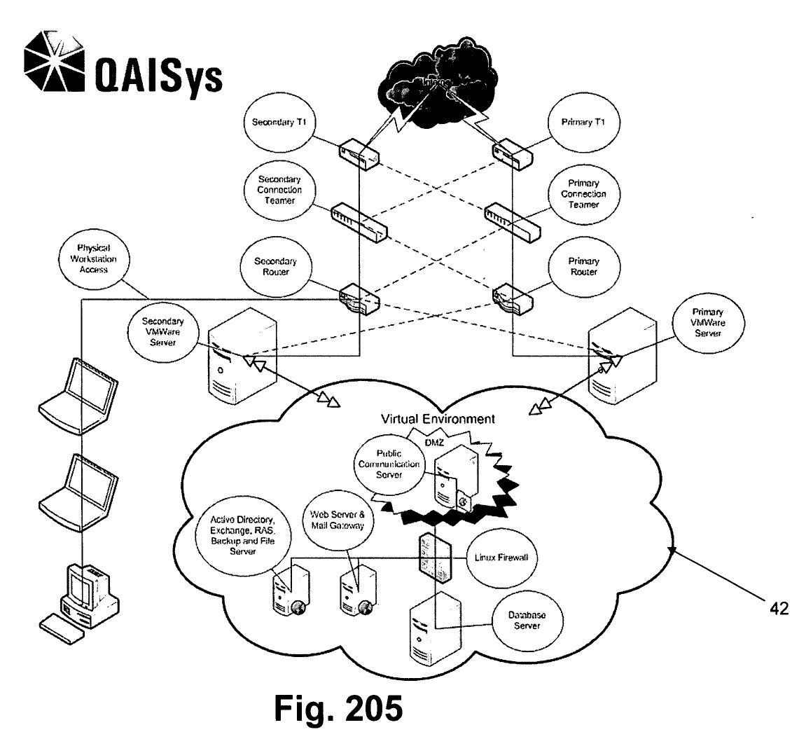

FIG. 205 is a diagram that shows an exemplary model of infrastructure of a GDC-QAISys.

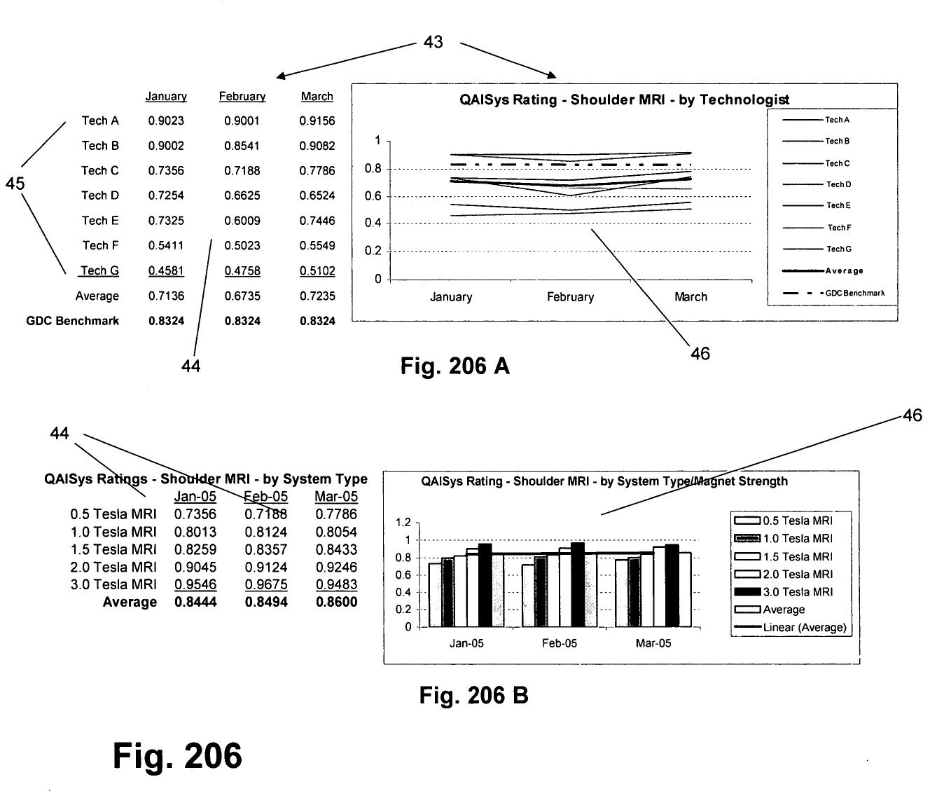

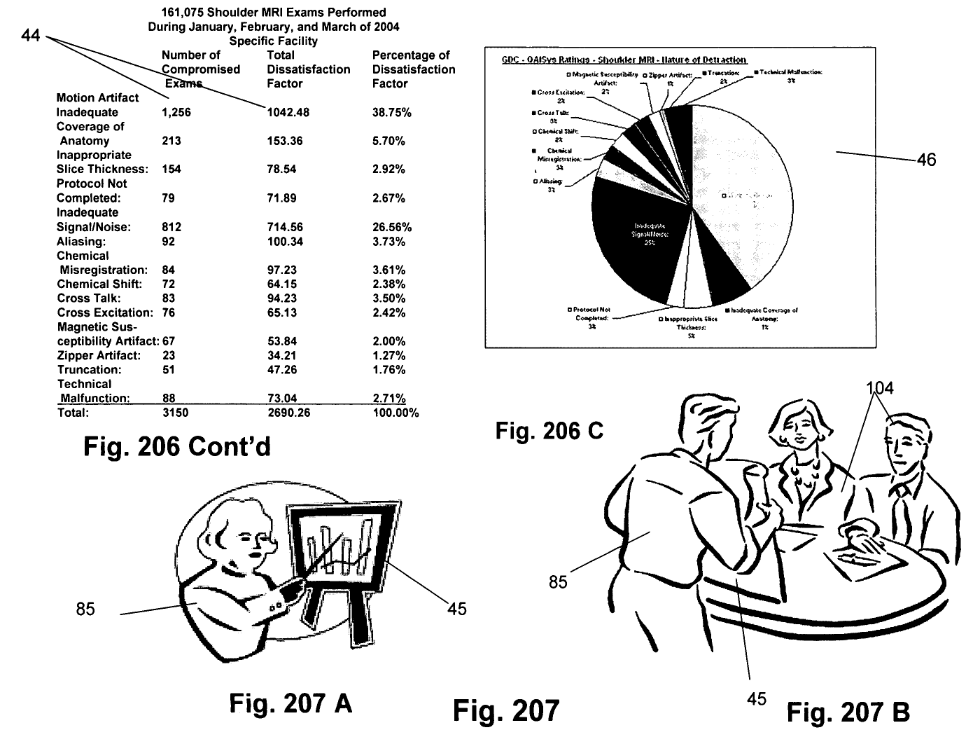

FIGS. 206 A, B, and C are examples of data and graphs indicating facility ratings for specific types of procedure.

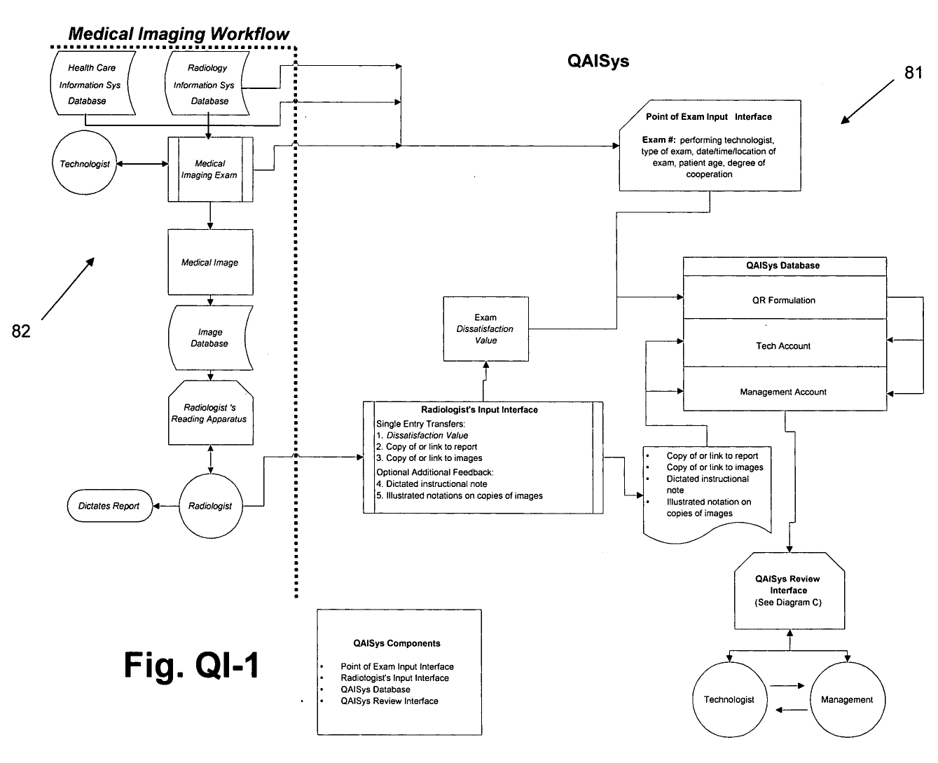

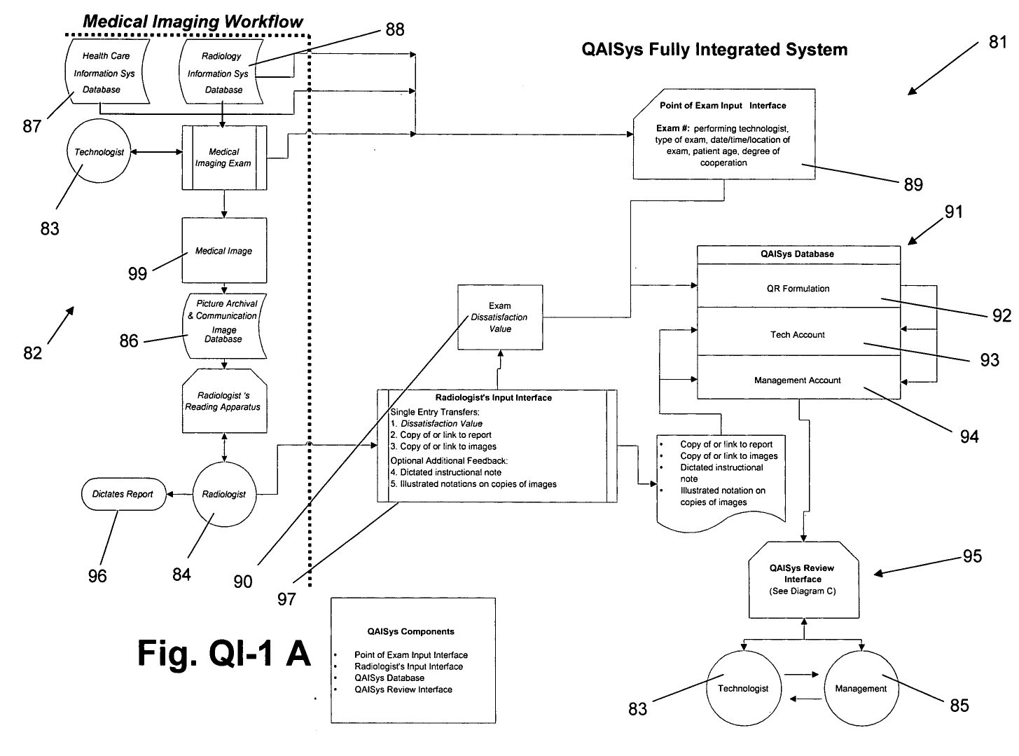

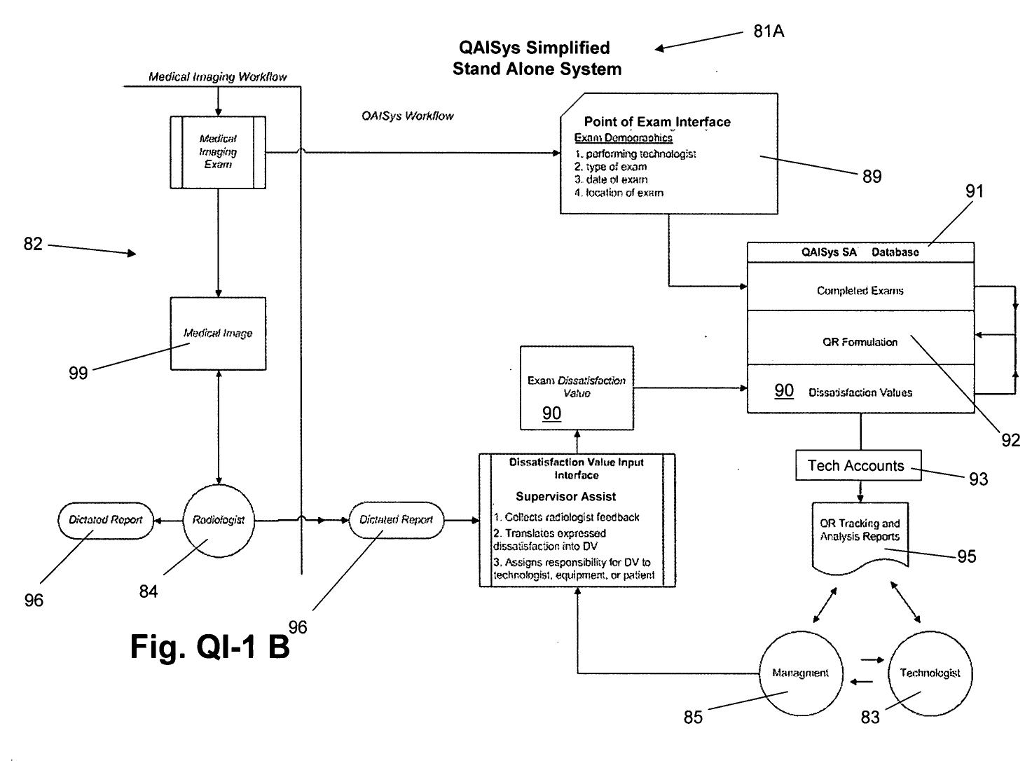

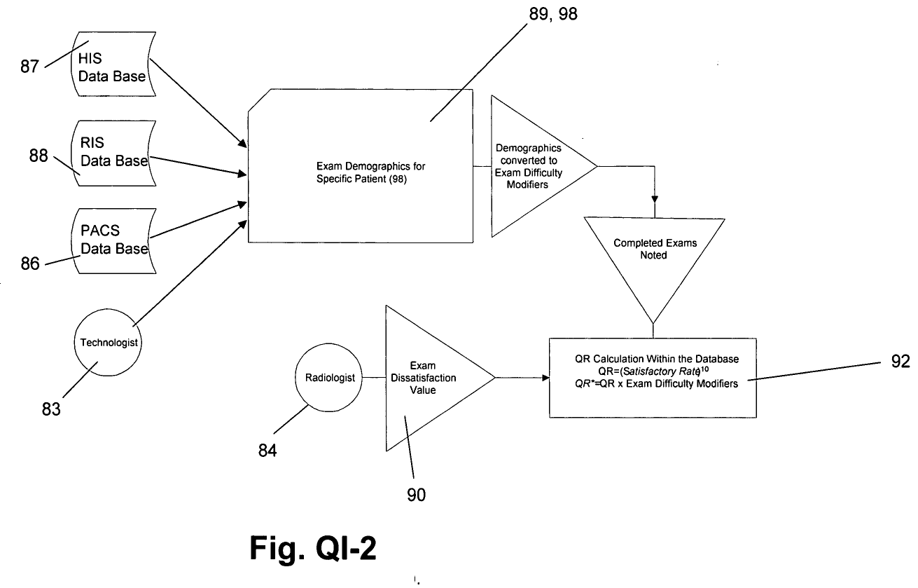

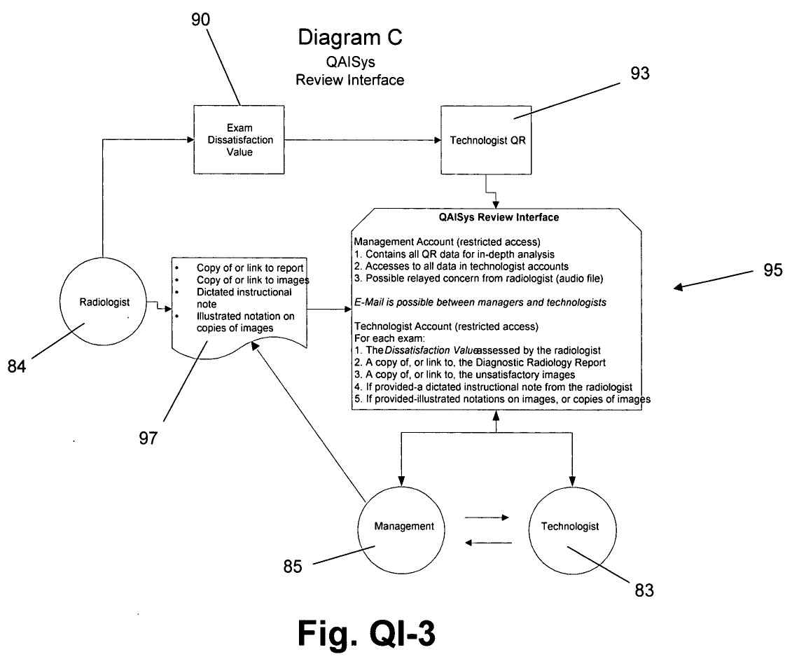

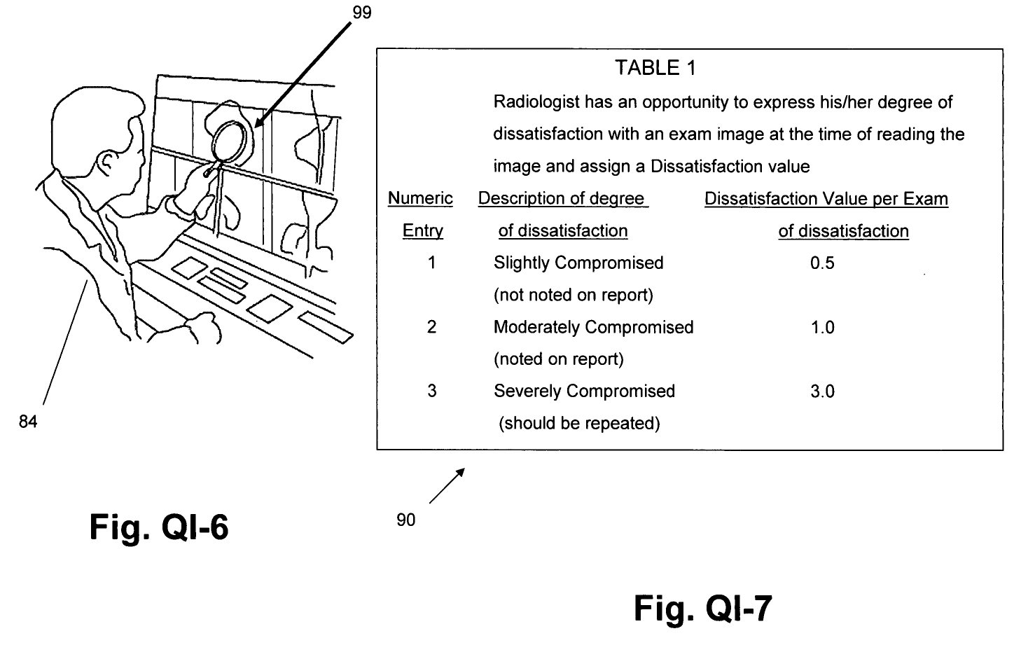

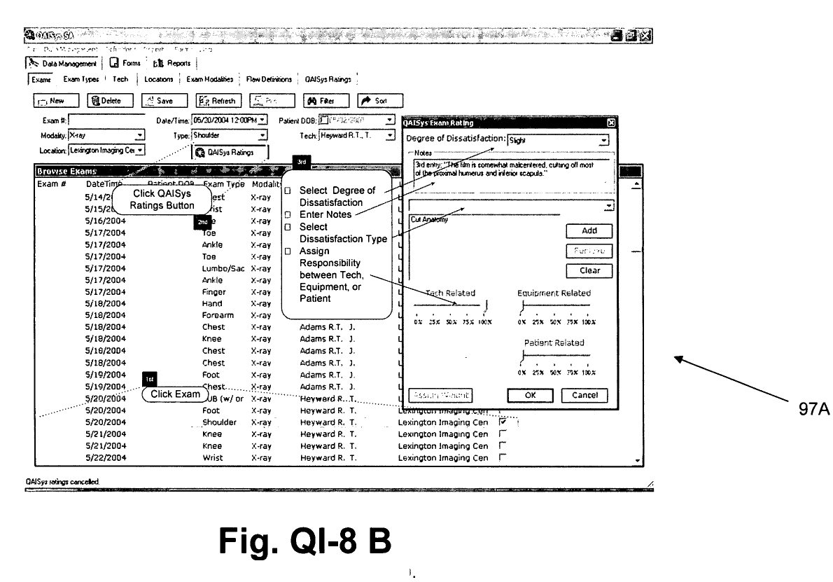

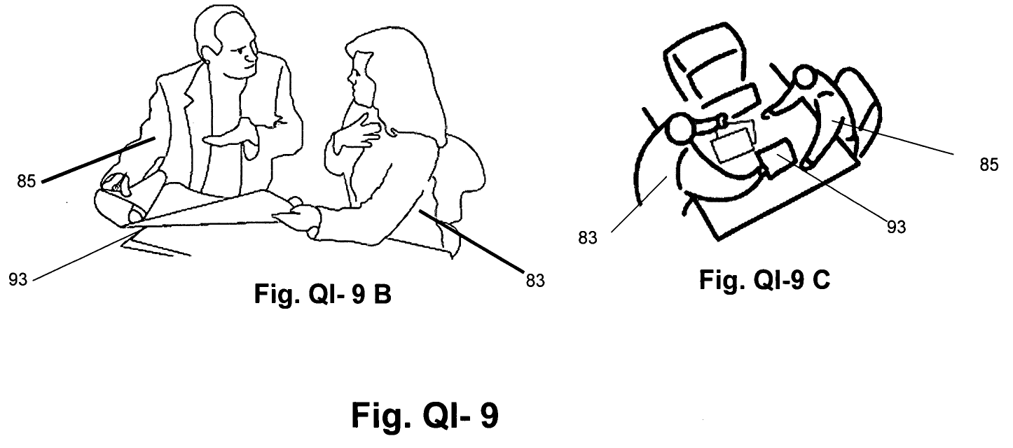

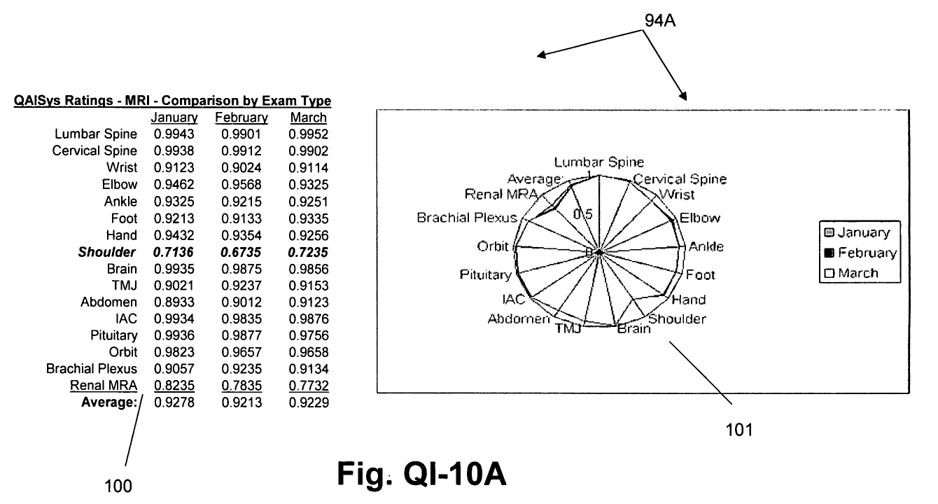

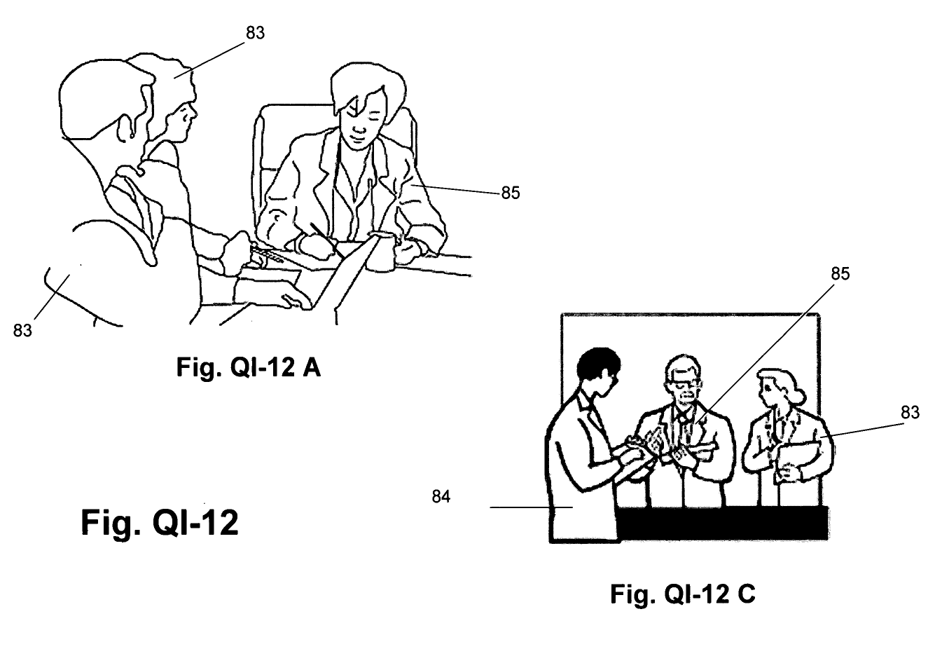

FIG. 207 is a sketch portraying reviews and discussions concerning improvements to health care procedures and tests.

A concrete example of a QAISys system is desired to help one understand the significance of the Global data center concept. The following “QI-” Figures are derived from the examples in patent application Ser. No. 11/125,527, filed May 10, 2005.

FIG. QI-1 is a Diagram or flowchart from QAISys of the existing PACS, HIS, and RIS system with the improved performance evaluation portion resulting in the QUALITY ASSESSMENT and IMPROVEMENT SYSTEM (QAISys) in MEDICAL IMAGING.

FIG. QI-1A is the FIG. QI-1 with the various components and portions of the diagram indicated by their respective reference numbers (see below). This is QAISys interposed on a relatively large, complex health care facility with highly sophisticated information systems.

FIG. QI-1B is the QAISys interposed on a relatively small, less complex health care facility.

FIG. QI-2 is a flow chart showing the input from the information systems and/or technologist and from the radiologist to the Quality Rating (QR) of the image.

FIG. QI-3 is a flow chart of the radiologist input and the feedback portion of QUALITY ASSESSMENT and IMPROVEMENT SYSTEM (QAISys) between the technologist and his/her manager.

FIG. QI-6 is a picture showing a radiologist reviewing the results of a medical imaging test.

FIG. QI-7 is a table used by a radiologist to evaluate and feedback any dissatisfaction with the quality of the image.

FIG. QI-8B shows an input interface for managers to use in the SA (Stand-Alone) software.

FIG. QI-9B shows a technologist and the manager reviewing data.

FIG. QI-9C shows a sketch of a review at a computer terminal.

FIG. QI-10A is an example table and graph of data from a group of technologists by modality and Quality Rating (QR).

FIG. QI-12 is series of pictures and sketches of Quality Review meetings. FIG. 12A is a group of colleagues reviewing data at a conference table and

FIG. QI-12C is a group of medical personnel reviewing data.

### REFERENCE NUMERALS

The following list refers to the accompanying pictures, tables, and drawings:

31 The general global datacenter method for improvement to healthcare facilities—GDC-QAISys

32 Main or Core Global Data Center—GDC

33 Communication/data link from the end user 34 to the Global Data Center 32

34 End user health care facility(ies) or group

35 Feedback and uplink connection from Global Data Center 32 back to the End User 34

36 Data sent from Global Data Center 32 to End User 34

37 Data sent from End User 34 to Global Data Center 32

38 PACS/RIS integrated QAISys implementations at a more complex health care facility(ies)

39 Simple/stand-alone implementation of QAISys at a healthcare facility with non-integrated hospital information systems

40 Semi-complex QAISys implementation with Radiology Information Systems(RIS) but no PACS interface

41 General Flowchart for the global data center and accompanying steps

42 Exemplary model of GDC infrastructure design

43 An example of shared data for specific tests in the BUSINESS METHOD USING A GLOBAL DATA CENTER FOR A QUALITY ASSESSMENT and IMPROVEMENT SYSTEM (QAISys)

44 Data for various facilities for a specific test type

45 Global Rating Values

46 Graphical demonstration of progress for the facilities in a certain type test/procedure

81 QAISys portion of method

81A Standalone QAISys implementation model for relatively smaller facilities

82 Existing Medical Imaging Workflow

83 Technologist

84 Radiologist

85 Manager or supervisor of Technologist

86 Image database [Picture Archiving and Communication System (PACS) or the like database]

87 Patient entry database [Health Care or Hospital Information System (HIS)or the like database]

88 Radiology Testing database [Radiology Information System (RIS) or the like database]

89 Point of Exam

90 Exam Dissatisfaction Value

91 QAISys resultant database

92 Means to formulate Quality Rating (QR)

93 Technologist Account within database

94 Management Account of all the data of all Technologists within the database

94A Management Account comparing QR by exam type (modality)

95 QAISys review interface

96 Radiologist Dictation

97 Radiologist's input interface

97A Radiologist's input with supervisor assist

98 Patient ready for exam

99 Exam image (exemplary not limiting)

100 Management Account table of data comparing QR by exam type(modality)

101 Management Account graph depicting a comparison of QR by exam type (modality)

104 Health Care Quality Certification Review Team

### DETAILED DESCRIPTION AND OPERATION OF THE PERFERRED EMBODIMENT

The present invention is a BUSINESS METHOD in Health Care Management. Specifically, this new method is a business method using a Global Data Center (GDC) for quality assessment and improvement to virtually any healthcare system (QAISys). The method provides a unique way to combine computer assisted data exchange with the implementation of administering, managing and operating the Quality improvement activities of healthcare groups. The method provides a technique to aid in the feedback, instruction, and improvement to the medical personnel and technologists. Overall national benchmarks of level of quality for healthcare procedures and tests are monitored and established. The method is specific to the facility improvement for the collective individual skills of the personnel and technologists. The preferred embodiment and “example” group demonstrated in this business method relates to technologists responsible for medical imaging. However, the alternative embodiment provides a way to combine various existing systems with simple, new analysis to accomplish concrete, useful and tangible results in improvement of the other healthcare areas utilizing this same business method.

There are improvements over the existing art. The BUSINESS METHOD USING A GLOBAL DATA CENTER FOR A QUALITY ASSESSMENT and IMPROVEMENT SYSTEM (GDC-QAISys):
a. facilitates increased communication between the professionals such as the radiologists, technologists, and radiology managers;
b. introduces systematic global performance accountability for healthcare professionals, the technologists, and the condition of equipment to the healthcare field including, but not limited to, the medical imaging process;
c. provides historical data and statistical trends which will broaden data comparisons and analysis for intra and inter-organizations or on a “global” scale.
   The data will be used to formulate Global QAISys Ratings (GQR) useful as benchmarks.
   The GQRs will be useful to professional leaders by enabling analysis that shows where improvement efforts should be made by the entire profession.
   The GQRs will be useful to healthcare technology developers by enabling them to identify areas where advances in technology might improve healthcare quality;
d. provides and facilitates communication to other hospital and health care administration as to quality assessment and quality improvement for healthcare exams and procedures;
e. provides a beneficial impact to health care costs with fewer “re-takes” of the procedures and tests lower liability exposure to physicians, health care providers, and technologists; and
f. delivers to health care providers, large hospitals or specific contract agencies the data to focus additional education and training for professionals and technologists.
g. enables broad licensing use of the QAISys concept without needing exclusivity.

There is shown in FIGS. 201 to 207 a complete operative embodiment of the business method facilitated by BUSINESS METHOD FOR MEDIICAL IMAGING USING A GLOBAL DATA CENTER FOR QUALITY ASSESSMENT and IMPROVEMENT SYSTEM (GDC-QAISys). In the drawings and illustrations, note well that the FIGS. 201 to 207 demonstrate the configuration and use of a business method for improving the quality of procedures and tests for medical images. This is accomplished by providing to healthcare facilities a national data exchange of benchmarks as to the level of quality for the various tests and procedures. In turn, these facilities may then seek to improve the performance capability of the healthcare professionals and technologists that perform the tests. Similar methods may be used for other healthcare areas.

FIG. 201 is a general diagram of the general global datacenter method 31 for improvement to healthcare facilities—GDC-QAISys. It shows a simplified business method for establishing a link and then sharing data relevant to quality improvement in medical imaging for a healthcare provider.

FIG. 202 is the same FIG. 201 with the various components and portions of the diagram indicated. The main or core Global Data Center—GDC 32 is where the data from the various end users 34 is stored and analyzed. Then the data is statistically manipulated to provide the national benchmarks and feedback to the end user 34. The Communication/data link 33 takes data input from and end user 34 and transfers it to the global center 32. Data transferred here is shown in the data box 37. This includes items such as exam demographics, dissatisfaction values and payments for services once they have been invoiced. In turn, the communication/data link 35 provides the data transmission from the global data center 32 to the end user 34. Data transferred here is shown in the data box 36. This includes items such as national benchmarks for various tests, certification of use to the end user 34, and invoices for the services provided.

FIG. 203 is an overview of how a stand alone system of QAISys for a facility 39, a medium integrated facilities 40, and an highly complex integrated healthcare groups 38, with multiple facilities, might be interconnected in a global data interchange system GDC-QAISys 31. Here, the core or main GDC 32 is integrated back to the various systems through the communication links 33 and 34. One skilled in the art or data transfer understands that these communication links may be over telephone lines, dedicated data lines, fiber optics, internet communications and even satellite links. The individual configuration is not important to the spirit and scope of the GDC-QAISys 31. What is critical, however, is that a means has been put in place to accomplish the transfer between the end user 34 and the GDC 32. One skilled also notes well that a Global Data Center 31 might also interconnect systems not using QAISys with the Global system 31 and still accomplish a use and interface with global benchmarks. However, one would be encouraged to use the same system in order to avoid translation costs or potential data conversion errors.

FIG. 204 is a basic FLOW CHART 41 demonstrating the essential steps for a BUSINESS METHOD USING A GLOBAL DATA CENTER FOR A QUALITY ASSESSMENT and IMPROVEMENT SYSTEM (GDC-QAISys) 31. There are many ways to accomplish the data exchange. Minor changes in these steps are anticipated. These changes do not affect the spirit and scope of this invention having a:
1. “QAISys like improvement method” 81 in place at the medical imaging department of a healthcare facility(ies);
2. GDC 32;
3. means for collecting data from the facility;
4. means for transmitting data to the GDC 32;
5. means for the GDC 32 to manipulate and analyze the data; and
6. means to provide quality benchmarks back to the individual facility or groups thereof.

This method would also incorporate the steps of initially putting the GDC-QAISys 31 and hardware in place, testing the data transfer, and establishing and performing a means to charge the facility and receive payment by the GDC 32 for the GDC-QAISys 31.

| Step | Action |
|---|---|
| 1 | Healthcare facility institutes a QAISys 81 |
| | “like” quality assessment and improvement |
| | system at its facility or group of |
| | facilities - specific to the medical imaging |
| | or alternatively to another area |
| 2 | Healthcare facility/group decides to |
| | implement a connection with the national |
| | system GDC-QAISys 31. |
| 3 | Healthcare facility/group contacts GDC- |
| | QAISys 31 “online” |
| 4 | Healthcare facility/group and GDC-QAISys 31 |
| | enter into a contract and encryption |
| | certificates are exchanged |
| 5 | Healthcare facilities uploads data to the |
| | GDC 32 |
| 6 | Data is checked for errors and corrected as |
| | necessary |
| 7 | GDC 32 downloads National quality benchmark |
| | data to Healthcare facility/group |
| 8 | Healthcare facility/group performs various |
| | QAISys 81 activities and uploads results to |
| | GDC on an ongoing basis |
| 9 | GDC 32 inputs the data from all the |
| | participating Healthcare facilities/groups |
| 10 | GDC 32 statistically and numerically analyze |
| | and organize the data from all the QAISys 81 |
| 11 | GDC 32 downloads National current |
| | (updated) benchmark data (specific to medical |
| | imaging or alternatively to other healthcare |
| | areas) to all the participating Healthcare |
| | facilities/groups |
| 12 | GDC invoices participating Healthcare |
| | facility/group for contracted services |
| 13 | Healthcare facility/group pays invoices and |
| | periodically renews contract or is |
| | terminated from contact with the GDC (de- |
| | certified) |
| 14 | Process is repeated periodically |

An important function for any business method is to turn the concrete, tangible system into a way to achieve some financial gain. In this vain, there are many techniques used to charge clients and receive payment for the services and data provided. In Table B, a few of these manners to generate charges and receive payment are listed. However, this list is not exhaustive and is shown as an example and not a limitation to the GDC-QAISys 31.

TABLE B
Ways to Generate Payment Charges

| Way | Description |
|---|---|
| 1 | Pay per each contact - pay on use based on |
| | several potential parameters . . . each use, total |
| | exams, etc |
| 2 | Pay License on each using terminal - seat |
| | usage fee |
| 3 | Pay a set, onetime fee per year for |
| | unlimited uses |
| 4 | Pay License fee to set-up system, then a |
| | royalty for each use |
| 5 | Pay an annual fee for use, then an annual |
| | bonus for extra income derived when |
| | insurance providers increase the allowance |
| | for tests using and improving its QR |
| | (internal or facility/group quality rating) |
| | against the GQR (national benchmark global |
| | quality rating). |

FIG. 205 is a diagram that shows an exemplary model of infrastructure of a GDC-QAISys. This interchange would exchange, analyze and statistically provide benchmark data to all participating healthcare providers specific to their own data compared with a national benchmark. No facility or group data would be shared to other users or insurance or healthcare advocacy groups—only benchmarks. The individual provider/group could then compare and improve in relation to the national benchmark as per management direction. This is done to monitor the individual provider's medical imaging quality level and to provide national statistics as to the quality of the medical imaging of the healthcare industry globally. This means for data transfer and manipulation has continued to undergo major technological advancements. From years past, data was exchanged through physical means such as paper charts, data disks, and magnetic tapes. Advancements in the exchange of data were brought by high speed data lines, by internet connections (data lines, fiber optics, wireless) and through satellite. These advances and changes in data exchange are likely to continue. However, regardless of what manner employed for data exchange, the GDC-QAISys 31 anticipates that the exchange of medical imaging and healthcare data with the GDC 32 in order to establish and share global benchmarks. This system and method anticipates continued advances in the means to accomplish the data exchange without disturbing or circumventing the spirit and scope of the GDC-QAISys 31. As an example of how a communication and data interchange might be established, this interchange would exchange, analyze and statistically provide benchmark data to all participating healthcare providers. This data provided to all the participating healthcare providers will help the providers to monitor their image quality in comparison with industry standards and to monitor the individual provider's quality level and improvement progress. By creating the global benchmark and updating the industry benchmarks, global statistics as to the quality of the healthcare industry would be available for improvement efforts.

FIGS. 206 A, B, and C are examples of data and graphs indicating specific facility ratings for definite types of procedure. Generally, FIGS. 206 A, B, and C are examples of the type of data each individual or group of facilities may have to compare against the global benchmark. A graph 46 indicating ratings of a group of technologists within a specific facility (or groups of healthcare facilities) for a specific type of procedure. This graph 46 is specific to one test. The examples 43 here is for shoulder MRIs. The data from various facilities is collected 44 and charted 46. The Global Data Rating 45 value is derived by statistically manipulating the data. Shown here is a simple average. However, one skilled in the science of statistics well appreciates the plethora of numerical and statistical analyses that may be performed on like data. The various tests and procedures within a facility or group of facilities will vary in the use and number. However, the concept of measuring the quality level and improvement or progress of the facility's rating against a global benchmark (for each of the various test types) provides a new and unique business method, especially for medical imaging, that will provide the healthcare industry concrete and tangible savings for their costs of medical images. Similarly, this concept may be used in the alternative with other healthcare tests and procedures and still be within the scope and spirit of the GDC-QAISys 31.

FIG. 207 are sketches portraying reviews and discussions concerning improvements to health care procedures and tests. In FIG. 207 A one manager or supervisor 85 discusses results from the Global Data Ratings GDR 45 and compares them with his/her own facility values. In FIG. 207 B, an healthcare quality certification review team 104 discusses global ratings 45 with a supervisor 85. Prior to the GDC-QAISys 31, this discussion would be focused mainly on internal data with no understanding of a benchmark for the whole healthcare industry. Now, this improvement conference may reference and compare to national benchmarks.

A concrete example of a working QAISys system is desired to help one understand the significance of the Global data center concept. The following “QI-” Figures are derived from the examples in patent application Ser. No. 11/125,527, filed May 10, 2005.

The following details are derived from prior art shown in patent application Ser. No. 11/125,527, filed May 10, 2005. This provides one example of a healthcare quality improvement system from which the BUSINESS METHOD USING A GLOBAL DATA CENTER FOR QUALITY ASSESSMENT and IMPROVEMENT SYSTEM (GDC-QAISys) might obtain data and input. One skilled in the art appreciates that there are more systems that could benefit from the GDC-QAISys. Therefore, the use of the prior art known as QAISys is considered exemplary and not limiting to the use and benefits of the BUSINESS METHOD USING A GLOBAL DATA CENTER FOR QUALITY ASSESSMENT and IMPROVEMENT SYSTEM (GDC-QAISys).

FIG. QI-1 is a general diagram or flowchart of the existing systems workflow 82 with the improved performance evaluation portion 81 resulting in the QUALITY ASSESSMENT and IMPROVEMENT SYSTEM (QAISys) in MEDICAL IMAGING.

FIG. QI-1A is the FIG. QI-1 with the various components and portions of the diagram indicated by their respective reference numbers. This flow method is QAISys interposed on a relatively large, complex health care facility with highly sophisticated information systems. The embodiment incorporates part of the existing workflow 82 of a traditional healthcare facility. The existing workflow 82, normally includes a health care information system (HIS or the like) which has a database 87 of various patient information. In the normal workflow 82, and specific to the medical imaging, is included a system for tracking the radiology information (RIS or an equivalent) which also has a database 88. This radiology information database 88 contains text data of past examination history of a patient for other completed tests, etc.; contains workflow drivers such as a work entry for a specific modality such as a CT, MRI, X-ray, etc.; and, contains other information for interfacing with a higher ranking information system (HIS). The transitioning most of the healthcare's documentation to digital databases has fostered the need and development of a archival and communication database 86 such as PACS or an equivalent. Here the digital record of the images is maintained.

The embodiment of the method also incorporates a QAISys workflow 81. There is a QAISys database 91 that interfaces with the existing databases of the normal workflow 82. These provide baseline data specific to an image, to the individual patient, to the health care facility, to the modality of the test, to the specific type of equipment used (especially as to the strength of the active magnets, etc for MRIs), to the radiologist 84 reading the image, to the technologist 83 performing the test, and the like. In addition to data from these systems, QAISys 81 receives data entry from a point of exam input 89 and from the radiologist 84 via a radiologist's input interface 97. This interface 97 provides a specific exam dissatisfaction value 90 (described below) as to a patient's image.

The QAISys database 91 utilizes the data in several ways. One utilization is an analytical means 92 to manipulate the data and to formulate a statistical quality rating for each exam. Another way is to maintain a specific account for an individual technologist 93. A further way is to provide a full account 94 for the manager of all the technologists. One skilled in the art of statistical manipulation of data appreciates fully the plethora of analysis possible with this QAISys database 91. The QAISys workflow 81 also incorporates a QAISys review interface 95. At this interface 95, the technologist 83 and the manager 85 have an opportunity to review the quality rating QR of the technologist 83 and determine actions for improvement of the performance capability of the technologist 83.

FIG. QI-1B is the QAISys interposed on a relatively small, less complex health care facility. The QAISys 81 is similarly interposed as a smaller, less complex QAISys standalone version 81A. Most of the work flow is the same. One notes the major changes: an absence of the hospital information system 87 and/or radiology information system 88; a more simplified technologist 93 appended to the QAISys database 92; and a supervisor assist 97A to support the radiologist's 84 inputs.

FIG. QI-2 is a flow chart showing the input from the information systems and/or technologist and from the radiologist to the Quality Rating (QR) of the image. Existing data systems provide particular information with respect to the exam that indicate specifics such as demographics, modalities of the tests, facility location, equipment, etc. Then the radiologist 84 reads the image which a technologist 83 had completed. The data is extracted through a system interface from the HIS database 87, the RIS database 88 and/or the PACS database 86. The data is available from the existing hospital databases or by manual entry. Therefore, at the point of exam input interface 89 demographics for every exam may be associated with an exam number and will include data such as date, time, location, type of exam, age of the patient, performing technologist, and exam difficulty factors. This information is then sent to the performing technologist's account 93 and a manager's account 94 within the QAISys database 91.

The point of exam 89 data input is also then augmented by the radiologist 84 through the exam dissatisfaction value 90. These data entries from existing systems 82, technologists 83 and radiologists 84 are all contained in the QAISys database 91. Then, the formulation means 92 to calculate or formulate a Quality Rating QR converts the data into a tangible rating for each test image specific to a patient 98 and technologist 83.

FIG. QI-3 is a more complex flow chart of the radiologist 84 input and the feedback portion of QUALITY ASSESSMENT and IMPROVEMENT SYSTEM (QAISys) 81 between the technologist 83 and his/her manager 85. The radiologist 84 input is accomplished through the radiologist input interface 97. The radiologist 84 may link a report to the image, dictate an instructional note, or place an illustration or note directly on the test image. Likewise, especially in small operations, the manager 85 may input data based on discussions with the radiologist 84 and the condition of the actual image. In addition, the radiologist 84 determines a dissatisfaction value 90, if appropriate, for the actual test image. The dissatisfaction value 90 is a key input to the QAISys database 91 and is used by the Quality Rating formulation means 92 to establish a quality rating (QR) for each test image. The specific test image rating is then transferred and maintained in the QAISys database 92 in the respective technologist account 93. One skilled in this data exchange well understands that the more complex data exchange is not readily possible with a stand alone system described within.

The balance of the QAISys system 81 has a QAISys review interface 95. At the review interface 95, the technologist 83 and his/her manager 85 have the opportunity to interact with data from the test images. The interface 95 permits an in depth review of progress or deterioration of the Quality Ratings (QR) for the technologist 83 specific to the test that the technologist 83 has completed. This data provides a basis for the manager 85 and technologist 83 to assess the performance capability and determine an action plan to improve the rating. This action plan may include additional education, training, or special on-the-job training with experienced staff for test modalities that need improved. The action plans may indicate a special capability of the technologist 83 that needs to be shared and transferred to other technologists 83 in the group in order to improve the overall performance of the group. FIG. QI-3 should note that this diagram shows input and feedback from the PACS/RIS integrated model of QAISys implementation. Many of the features discussed in that diagram are not possible with standalone or even RIS integrated implementations.

FIG. QI-6 is a picture showing a radiologist 84 reviewing the result of a medical imaging test 99. At this point, the radiologist 84 uses the radiologist input interface 97 to provide information respective to the image 99 and what the image 99 specifically denotes. This is an opportune time for the radiologist 84 to decide on the quality of the image and provide a dissatisfaction value 90, if appropriate, for the patient 98 and technologist 83 specific to the image 99.

FIG. QI-7 is a table used by a radiologist 84 and manager 85 to timely evaluate and feedback any dissatisfaction value 90 with the quality of the image 99. The example (1, 2, or 3) is specific to the individual patient's exam and rates an image 99 as slightly compromised (1), moderately compromised (2), and severely compromised (3). A simple numerically keyed entry—1, 2, or 3—determines a Dissatisfaction Value 90 per exam. The recommended values respective of the numeric entry are 0.5 for a slightly compromised image 99; 1.0 for a moderately compromised image 99; and 3.0 for a severely compromised image 99.

FIG. QI-8B shows an input interface for managers to use in the SA (Stand-Alone) software. This is a prototype screen provided as an example of a typical feedback mechanism for a radiologist to use to input evaluation data to the database for the image that the radiologist recently “read”. The radiologist 84 and supervisor 85 uses the data and work hand in hand to provide accurate and helpful data in evaluating a technologist's 83 deficiencies, training needs and progress. This diagram shows an input interface for managers to use in the SA software.

FIG. QI-9B shows a technologist 83 and the manager 85 reviewing data from the individual technologist account 93. FIG. QI-9C shows a generic sketch of a review at a computer terminal between a technologist 83 and his/her manager 85. They are discussing data from the technologist's account 93.

FIG. QI-10A is a table and graph that compares the QR for different types of MRI exams performed within a medical imaging organization. It could by technologist, scanner, or facility (location) specific, or it could be for all MRI exams performed within the entire organization. An example table 100 and graph 101 of data from a group of technologists by modality and Quality Rating (QR). Here, the compilation of data into the QAISys database 91 is captured and formulated by a statistical means 92. The results are transferred to the manager's account 94(A). That account, in turn, may be queried and statistically manipulated to provide data in order to generate comparison for tables, graphs and other numerical analysis presentations.

FIG. QI-12 is a series of pictures and sketches of Quality Review meetings. FIG. QI-12A is a group of colleague technologists 83 and their manager 85 reviewing data at a conference table. FIG. QI-12C is a group of medical personnel (a technologist 83, a radiologist 84, and a manager 85 reviewing results of the data queries.

In the health care industry, there has been an increase interest for certification, especially focused on quality assessment and improvement. The scope and spirit of the method presented here may be transformed and modified to provide additional outputs and reports. These outputs and reports can provide and satisfy many specific certification requirements or formatted data for the imaging organizations in a specific health care facility. Alternatively, this same method may provide improvements against a national benchmark for other healthcare departments.

In total, all the points and details mentioned here throughout this detailed description of the drawings are exemplary and not limiting. Other components specific to describing a business method for quality assessment and improvement in the medical imaging may be added. A person having ordinary skill in the field of these types of business methods well appreciates this possibility of additions. The drawings and components have been focused on the parts shown in respect to the instant invention.

These uses for the new BUSINESS METHOD USING A GLOBAL DATA CENTER FOR QUALITY ASSESSMENT and IMPROVEMENT SYSTEM (GDC-QAISys) are merely exemplary and not limiting to the myriad of uses for a business method that is such as the present innovation. The GDC-QAISys has been described above in connection with what is presently considered to be the most practical and preferred embodiment of the business method for creating and using national benchmarks in the health care industry. With this description it is to be understood that GDC-QAISys is not to be limited to the disclosed embodiment. On the contrary, the new method is intended to cover various modifications and equivalent arrangements included within the spirit and scope of the description.

1. A business method for improving the quality of medical imaging results by exchanging and using quality assessment data, the method comprising:
a). a QAISys like improvement method in place at the healthcare facilities which provides the assessment data;
b). a global data center (GDC);
c). a means for exchanging data and services between the QAISys of the healthcare facility and the GDC; and
d). a means to charge the health care facility for services and receive payment for the services by the GDC whereby the data is collected and the GDC generates national quality benchmarks for various tests and procedures, where in turn the benchmarks are fed back to the medical imaging departments for healthcare facilities/groups and the data is utilized with the healthcare professionals for specific improvement of the tests and procedures.

2. The method according to claim 1 wherein the means to charge the health care facility for services and receive payment for the services by the GDC means for entering the evaluation is by a pay on use for each contact made by the healthcare facility to the GDC.

3. The method according to claim 1 wherein the means to charge the health care facility for services and receive payment for the services by the GDC means for entering the evaluation is by a license charged for each terminal of the healthcare facility that accesses the database of the GDC.

4. The method according to claim 1 wherein the means to charge the health care facility for services and receive payment for the services by the GDC means for entering the evaluation is by charging the healthcare facility a onetime charge per year for unlimited use and access to the GDC data and quality benchmarks.

5. The method according to claim 1 wherein the means to charge the health care facility for services and receive payment for the services by the GDC means for entering the evaluation is by paying a set-up fee at the initial phase, then a royalty per year for measured usage.

6. The method according to claim 1 wherein the means to charge the health care facility for services and receive payment for the services by the health care facility paying a set-up fee to the GDC, then paying an annual bonus payment for extra income derived when insurance providers increase the allowance for tests using and improving its QR (internal or facility/group quality rating) against the GQR (national benchmark global quality rating).

7. The method according to claim 1 wherein the means to charge the health care facility for services and receive payment for the services by the health care facility paying a pay on use fee derived from the total number of completed exams included in the study regardless of whether each exam is rated adequate or in need of improvement.

8. The method according to claim 1 wherein the means for exchanging data and services between the QAISys of the healthcare facility and the GDC is selected from a group consisting of paper files, magnetic disks, magnetic tapes, internet transmissions, fiber optic lines, data transmission lines, and satellite connections and communications.

9. A business method for improving the quality of healthcare imaging test results by exchanging and using quality assessment data, the method comprising:
a). Healthcare facility institutes a QAISys “like” quality assessment and improvement system at its facility or group of facilities;
b). Healthcare facility/group decides to implement a connection with the national system GDC-QAISys;
c). Healthcare facility/group contacts GDC-QAISys “online”;
d). Healthcare facility/group and GDC-QAISys enter into a contract and encrypted certifications are exchanged;
e). Healthcare facilities uploads data to the GDC;
f). Data is checked for errors and corrected as necessary;
g). GDC downloads National quality benchmark data to Healthcare facility/group;
h). Healthcare facility/group performs various QAISys activities and uploads results to GDC on an ongoing basis;
i). GDC inputs the data from all the participating Healthcare facilities/groups;
j). GDC statistically and numerically analyze and organize the data from all the QAISys at the healthcare facilities;
k). GDC downloads National current (updated) quality benchmark data to all the participating Healthcare facilities/groups;
l). GDC invoices participating Healthcare facility/group for contracted services;
m). Healthcare facility/group pays invoices and periodically renews contract or is terminated from contact with the GDC (de-certified); and
n). Process is repeated periodically
whereby the data is collected and the GDC generates national quality benchmarks for various tests and procedures, where in turn the benchmarks are fed back to the healthcare facilities/groups and the data is utilized with the healthcare professionals for specific improvement of the tests and procedures.

10. A business method for improving the quality of medical imaging results by exchanging and using quality assessment data, the method comprising:
a). a QAISys like improvement method in place at the healthcare facilities which provides the assessment data;
b). a global data center (GDC);
c). a means for exchanging data and services between the QAISys of the healthcare facility and the GDC; and
d). a means to charge the health care facility for services and receive payment for the services by the GDC whereby the data is collected and the GDC generates national quality benchmarks for various tests and procedures, where in turn the benchmarks are fed back to the medical imaging departments for healthcare facilities/groups and the data is utilized with the healthcare professionals for specific improvement of the tests and procedures.

11. The method according to claim 10 wherein the means to charge the health care facility for services and receive payment for the services by the GDC means for entering the evaluation is by a pay on use for each contact made by the healthcare facility to the GDC.

12. The method according to claim 10 wherein the means to charge the health care facility for services and receive payment for the services by the GDC means for entering the evaluation is by a license charged for each terminal of the healthcare facility that accesses the database of the GDC.

13. The method according to claim 10 wherein the means to charge the health care facility for services and receive payment for the services by the GDC means for entering the evaluation is by charging the healthcare facility a onetime charge per year for unlimited use and access to the GDC data and quality benchmarks.

14. The method according to claim 10 wherein the means to charge the health care facility for services and receive payment for the services by the GDC means for entering the evaluation is by paying a set-up fee at the initial phase, then a royalty per year for measured usage.

15. The method according to claim 10 wherein the means to charge the health care facility for services and receive payment for the services by the health care facility paying a set-up fee to the GDC, then paying an annual bonus payment for extra income derived when insurance providers increase the allowance for tests using and improving its QR (internal or facility/group quality rating) against the GQR (national benchmark global quality rating).

16. The method according to claim 10 wherein the means for exchanging data and services between the QAISys of the healthcare facility and the GDC is selected from a group consisting of paper files, magnetic disks, magnetic tapes, internet transmissions, fiber optic lines, data transmission lines, and satellite connections and communications.

17. The method according to claim 10 wherein the QAISys like improvement method in place at the healthcare facilities which provides the assessment data includes data respective of the type and strength of the analysis equipment used for the tests.

18. The method according to claim 10 wherein the QAISys like improvement method in place at the healthcare facilities provides the assessment data to compare individual technologist improvement against the global benchmark for the various type of medical imaging procedures used at the facility.

19. The method according to claim 10 wherein the QAISys like improvement method in place at the healthcare facilities provides the assessment data to compare the facility and its group against the global benchmark for other facilities in respect to the various type of medical imaging procedures used at the facility.

20. The method according to claim 10 wherein the means to charge the health care facility for services and receive payment for the services by the health care facility paying a pay on use fee derived from the total number of completed exams included in the study regardless of whether each exam is rated adequate or in need of improvement.
